(19) United States
(12) Patent Application Publication
(10) Pub. No.: US 2026/0140035 A1
(43) Pub. Date: May 21, 2026

(54) Measurement Cuvette and Method for Determining Concentration of Particulate Suspensions

(71) Applicant: QINGDAO TANWEI BIOTECHNOLOGY CO., LTD., Qingdao (CN)

(72) Inventors: Lichuan GU, Qingdao (CN); Hongwei WANG, Qingdao (CN); Carina Muyao GU, Qingdao (CN)

(73) Assignee: QINGDAO TANWEI BIOTECHNOLOGY CO., LTD., Qingdao (CN)

(21) Appl. No.: 19/449,337

(22) Filed: Jan. 14, 2026

Related U.S. Application Data
(63) Continuation of application No. PCT/CN2024/095986, filed on May 29, 2024.

(30) Foreign Application Priority Data
Jul. 14, 2023 (CN) 202310866504.0

(51) Int. Cl. G01N 15/075

(52) U.S. Cl. CPC G01N 15/075

(57) ABSTRACT

A measurement cuvette and a method for determining a concentration of a particulate suspension are disclosed. The measurement cuvette is formed of a fully transparent material and has an L-shaped cross section defined by removal of a rectangular notch from a square body. The method comprises introducing a particulate suspension into the cuvette and measuring absorbance at a plurality of optical path lengths including a maximum optical path length, an intermediate optical path length, and a minimum optical path length to obtain corresponding optical density (OD) values. Weighting factors are dynamically calculated based on a functional relationship among the OD values, and the OD values are combined using the calculated weighting factors to generate a final OD value representative of the concentration of the particulate suspension.

### RELATED APPLICATIONS

The present patent document is a continuation of PCT application Serial No. PCT/CN2024/095986, filed May 29, 2024, designating the United States and published in English, which is hereby incorporated by reference.

The present patent document claims the benefit of priority to patent application No. 202310866504.0, filed Jul. 14, 2023, and entitled “MEASUREMENT CUVETTE AND METHOD FOR DETERMINING CONCENTRATION OF PARTICULATE SUSPENSIONS,” the entire contents of each of which are incorporated herein by reference.

### BACKGROUND

### 1. Technical Field

The present disclosure relates to the technical field of detection and analysis of particulate suspensions, and in particular to a measurement cuvette and a method for determining a concentration of a particulate suspension.

### 2. Background Information

The statements here merely provide background information related to the present disclosure and do not necessarily constitute the prior art.

The concentration of a particulate suspension refers to the content of particulates per unit volume. Common examples of particulate suspensions include ink, muddy water, and correction fluid, as well as various microbial culture solutions. The concentration of a suspension is generally determined using spectrophotometry, and the principle of this detection method is that when a light beam passes through the suspension, the transmittance of the light beam decreases due to scattering or absorption by the particles. When the concentration of the suspension is relatively low, the transmission of light obeys the Beer-Lambert Law. Within a certain range, the concentration of the particulates is proportional to the optical density (OD value) and inversely proportional to the transmittance of light.

Although spectrophotometry is simple and rapid, it can only directly and accurately determine the concentration of the particulate suspension with an OD value not exceeding 1.0. When the concentration of particulates is high, the Beer-Lambert law is not applicable any more due to secondary reflection of light, resulting in a situation that an OD reading is significantly lower than an actual value, the higher the concentration, the greater the deviation. Therefore, for the suspension with a relatively high OD value, dilution is required until the OD value falls within the specified range for accurate measurement. This process is cumbersome, and readings may fluctuate abruptly between diluted and undiluted suspensions, resulting in poor stability and reduced accuracy. For microbial culture solutions, the process of de-capping for sampling and dilution may not only cause contamination but also disrupt microbial growth conditions. Such operations are entirely unacceptable for anaerobic microorganisms.

### BRIEF SUMMARY

For the disadvantages in the prior art, an objective of the present disclosure is to provide a measurement cuvette and a method for determining a concentration of a particulate suspension. By using this method, the concentration of the liquid can still be directly and accurately detected without diluting when an actual OD value of the particulate suspension far exceeds 1.0, so that the efficiency and accuracy of detection are greatly improved.

To achieve the objective, the present disclosure is implemented through the technical solution as follows.

According to a first aspect, the present disclosure provides a measurement cuvette for determining a concentration of a particulate suspension, where the measurement cuvette has an L-shaped cross section defined by removal of a rectangular notch from a square body; and
the cuvette is formed of a fully transparent material.

In some embodiments, the cuvette is made of polystyrene.

In some embodiments, the cuvette has a height ranging from 4 cm to 5 cm.

In some embodiments, a square cross section of the cuvette has a side length ranging from 0.8 cm to 1.2 cm.

Preferably, the square cross section of the cuvette has a side length of 1 cm, and the rectangular notch has a length ranging from 7 mm to 9 mm and a width ranging from 5 mm to 6 mm.

According to a second aspect, the present disclosure provides a method for determining a concentration of a particulate suspension, including the following steps:
introducing a particulate suspension to be tested into a cuvette, and measuring absorbance of the cuvette at a plurality of optical path lengths, where a maximum optical path length of the cuvette is an optical path length 1, an intermediate optical path length is an optical path length 2, and minimum optical path length is an optical path length 3;
a weighting factor of an OD (Optical Density) value of the optical path length 1 is w1=X1/(X1+bX2E+cX3F),
a weighting factor of an OD value of the optical path length 2 is w2=bX2E/(X1+bX2E+cX3F),
a weighting factor of an OD value of the optical path length 3 is w3=cX3F/(X1+bX2E+CX3F), and
a final OD value of the particulate suspension is X=w1X1+w2X2+w3X3;
X1 is an OD value corresponding to the optical path length 1, X2 is an OD value corresponding to the optical path length 2, and X3 is an OD value corresponding to the optical path length 3; and
b and c are real numbers and greater than or equal to 0, and E and F are real numbers and greater than or equal to 0.
b and c are real numbers and greater than or equal to 0, specific values of which are provided by experimental data, and these two parameters determine at which concentration the weighting factors of the optical path lengths 2 and 3 exceed the weighting factor of the previous optical path length. E and F are positive real numbers, optimal specific values of which are provided by experimental data, and these two parameters determine a rate at which the weighting factor of the corresponding optical path increases; and the larger the exponent, the faster the increase rate. In general, E and F may be positive integers.

In some embodiments, specific values of b and c are calibrated via a preliminary experiment using a substance to be tested, such that the maximum optical path length has a highest weighting factor at a low concentration, and the minimum optical path length has the highest weighting factor at a high concentration.

In some embodiments, specific values of E and F are calibrated via a preliminary experiment using a substance to be tested, such that the maximum optical path length has a highest weighting factor at a low concentration, and the minimum optical path length has the highest weighting factor at a high concentration.

Values of b, c, E and F are calibrated via a preliminary experiment of a certain substance to be tested, the principle is that at the low concentration, a 1 cm optical path length (maximum optical path length) has the highest weighting factor. As the concentration increases, weighting factors of 5 mm or 4 mm (intermediate optical path length) and 2 mm or 1 mm (minimum optical path length) gradually increase, such that at the high concentration, the 2 mm or 1 mm optical path length (minimum optical path length) has the highest weighting factor. Integers adopted in the embodiments are empirical constants derived from observed data, and an error in this case is sufficiently small. More accurate parameters can be obtained by numerical fitting. Once the values of b, c, E and F are determined, the values can be directly used for subsequent measurement of similar particulates.

In some embodiments, when detected by spectrophotometry, the particulate suspension to be tested has an absorbance exceeding 1.0.

Beneficial effects obtained by one or more embodiments of the present disclosure are as follows.

By adopting a cuvette and a detection method provided by the present disclosure, when a concentration of the particulate suspension to be tested is relatively low, a 1 cm optical path length has the highest weighting factor. As the concentration increases, the weighting factor of the 1 cm optical path length decreases continuously, while the weighting factor of the shorter optical path length increases continuously. An OD value of the particulate suspension to be tested is weighted average of readings of various optical path lengths. This solves both the problem of low OD reading at the high concentration and the problem of discontinuity between diluted and undiluted data.

### BRIEF DESCRIPTION OF THE DRAWINGS

The accompanying drawings, which constitute a part of the present disclosure, serve to provide a further understanding of the present disclosure. Illustrative embodiments of the present disclosure and descriptions thereof are used to explain the present disclosure and do not constitute undue limitations on the present disclosure.

FIG. 1 is a diagram of a cross-sectional structure of a cuvette used in a method for accurately determining a particulate concentration according to the present disclosure.

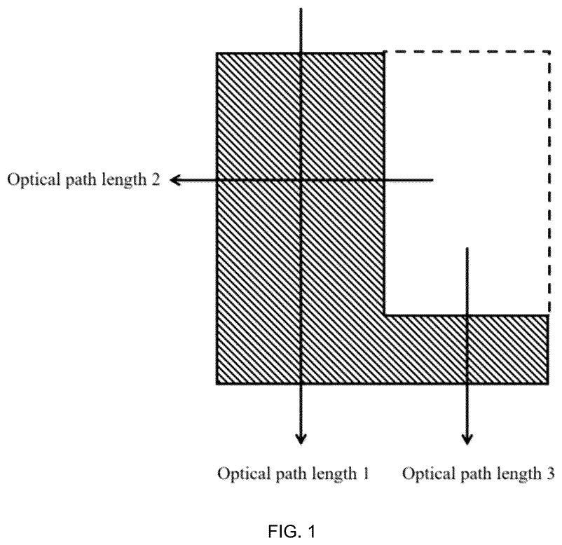

### DETAILED DESCRIPTION OF THE DRAWINGS AND THE PRESENTLY PREFERRED EMBODIMENTS

It should be noted that the following detailed description is illustrative and is intended to provide further description of the present disclosure. Unless otherwise defined, all technical and scientific terms used in the present disclosure have the same meaning as commonly understood by those of ordinary skill in the art.

The present disclosure is further described below with reference to embodiments.

### Embodiment 1

An LB medium suitable for culturing Escherichia coli is prepared: 1 g of peptone powder, 0.5 g of yeast extract, 1 g of sodium chloride powder, and 100 ml of distilled water are added into a 300 ml Erlenmeyer flask separately, and then a mouth of the flask is sealed with tinfoil. The flask is placed in a high-pressure steam sterilizer for sterilization at 121° C. for 20 min for later use.

100 μL of Escherichia coli is pipetted from a preserved Escherichia coli strain and added to the foregoing LB medium that has returned to a room temperature, and then an appropriate amount of the corresponding antibiotic is added to obtain a culture. Afterwards, the culture is placed in a constant-temperature shaking incubator and cultured at 37° C. and 220 rpm for 16 hours.

The Escherichia coli solution is serially diluted using distilled water to obtain Escherichia coli solutions which are numbered 1-11 in Table 1 and have concentrations decreasing in sequence. 3 ml of each of the foregoing eleven Escherichia coli solutions of different concentrations is added into a cuvette designed in the present disclosure, the cuvette is placed into a cuvette holder of a spectrophotometer, a wavelength is set to 600 nanometers, and OD values at three optical path lengths of 1 cm, 5 mm, and 2 mm are detected, which are designated as X1, X2, and X3, respectively.

According to experimental data, it is set that b=4, c=8, E=2, F=3, w1=X1/(X1+4X22+8X33), w2=4X22/(X1+4X22+8X33), and w3=8X33/(X1+4X22+8X33). The final OD value which is equal to w1X1+w2X2+w3X3 can be calculated by multiplying X1, X2, and X3 by coefficients w1, w2, and w3, respectively.

In addition, after the particulate suspension is diluted 2-fold and 5-fold, respectively, an OD value at a 1 cm optical path length is detected, then the OD value is multiplied by dilution factors separately to obtain particulate concentrations detected by a dilution method, which are denoted as X1-2 and X1-5, respectively.

Test and calculation results are shown in Table 1.

TABLE 1

| Strain | | | | | | Final OD |
|---|---|---|---|---|---|---|
| number | X1 | X1-2 | X1-2 | X2 | X3 | reading |
| 1 | 2.051 | 2.696 | 2.955 | 2.724 | 3.115 | 3.065 |
| 2 | 1.823 | 2.214 | 2.335 | 2.134 | 2.325 | 2.289 |
| 3 | 1.682 | 1.960 | 2.140 | 1.908 | 2.065 | 2.031 |
| 4 | 1.373 | 1.486 | 1.560 | 1.444 | 1.535 | 1.510 |
| 5 | 1.120 | 1.192 | 1.240 | 1.160 | 1.200 | 1.185 |
| 6 | 0.911 | 0.962 | 1.010 | 0.928 | 0.995 | 0.970 |
| 7 | 0.719 | 0.762 | 0.805 | 0.728 | 0.795 | 0.766 |
| 8 | 0.529 | 0.558 | 0.600 | 0.538 | 0.585 | 0.559 |
| 9 | 0.383 | 0.398 | 0.430 | 0.374 | 0.425 | 0.396 |
| 10 | 0.284 | 0.296 | 0.335 | 0.290 | 0.330 | 0.301 |
| 11 | 0.180 | 0.196 | 0.215 | 0.184 | 0.220 | 0.190 |

As can be seen from Table 1, different weighting factors are assigned to different optical path lengths at different concentrations by using a weighting method, and both the problem of low OD reading at a high concentration and the problem of discontinuity between diluted and undiluted data are solved.

At a low concentration, the final OD reading approaches X1, and at the high concentration, the final OD reading approaches X3. This solves the problem of relatively low X1 reading at the high concentration, and no dilution is required.

### Embodiment 2

A BMGY medium suitable for culturing yeast is prepared: 400 ml of glycerol, 10 ml of 1 M potassium phosphate buffer (with pH of 6.0), and 80 ml of distilled water are added to a 300 ml Erlenmeyer flask, and then a mouth of the flask is sealed with tinfoil. The flask is placed in a high-pressure steam sterilizer for sterilization at 121° C. for 20 min for later use. Then, 10 mL of filter-sterilized yeast nitrogen base stock solution at a concentration of 134 g/L is added to the foregoing medium in an ultra-clean bench.

100 μL of yeast is pipetted from a preserved yeast strain and added to the foregoing BMGY medium to obtain a culture. The culture is then placed in a constant-temperature shaking incubator and cultured at 37° C. and 260 rpm for 24 hours.

The yeast solution is serially diluted using distilled water to obtain yeast solutions which are numbered 1-17 in Table 2 and have concentrations decreasing in sequence. 3 ml of each of the foregoing seventeen yeast solutions of different concentrations is added into a cuvette designed in the present disclosure, the cuvette is placed into a cuvette holder of a spectrophotometer, a wavelength is set to 600 nanometers, and OD values at three optical path lengths of 1 cm, 4 mm, and 1 mm are detected, which are designated as X1, X2, and X3, respectively.

According to experimental data, it is set that b=c=4, E=2, and F=4, so that w1=X1/(X1+4X22+4X34), w2=4X22/(X1+4X22+4X34), and w3=4X34/(X1+4X2 2+4X34). The final OD value which is equal to w1X1+w2X2+w3X3 can be calculated by multiplying X1, X2, and X3 by coefficients w1, w2, and w3, respectively.

In addition, after the particulate suspension is diluted 2.5-fold and 10-fold, respectively, an OD value at a 1 cm optical path length is detected, then the OD value is multiplied by dilution factors separately to obtain particulate concentrations detected by a dilution method, which are denoted as X1-2.5 and X1-10, respectively.

Test and calculation results are shown in Table 2.

TABLE 2

| Strain | | | | | | Final OD |
|---|---|---|---|---|---|---|
| number | X1 | X1-2.5 | X1-10 | X2 | X3 | reading |
| 1 | 2.665 | 4.959 | 11.610 | 4.904 | 10.820 | 10.809 |
| 2 | 2.484 | 4.471 | 9.700 | 4.445 | 8.770 | 8.755 |
| 3 | 2.229 | 3.831 | 7.270 | 3.786 | 6.510 | 6.487 |
| 4 | 2.008 | 3.331 | 5.530 | 3.267 | 5.160 | 5.130 |
| 5 | 1.816 | 2.924 | 4.600 | 2.867 | 4.680 | 4.647 |
| 6 | 1.636 | 2.441 | 3.600 | 2.408 | 2.970 | 2.925 |
| 7 | 1.491 | 2.028 | 2.710 | 2.040 | 2.360 | 2.313 |
| 8 | 1.273 | 1.646 | 2.010 | 1.586 | 1.670 | 1.638 |
| 9 | 1.093 | 1.342 | 1.610 | 1.274 | 1.300 | 1.279 |
| 10 | 0.925 | 1.082 | 1.250 | 1.040 | 1.060 | 1.039 |
| 11 | 0.792 | 0.896 | 1.010 | 0.884 | 0.940 | 0.898 |
| 12 | 0.616 | 0.686 | 0.790 | 0.672 | 0.730 | 0.681 |
| 13 | 0.563 | 0.628 | 0.670 | 0.612 | 0.610 | 0.601 |
| 14 | 0.465 | 0.518 | 0.540 | 0.492 | 0.490 | 0.484 |
| 15 | 0.341 | 0.364 | 0.420 | 0.356 | 0.360 | 0.351 |
| 16 | 0.239 | 0.254 | 0.260 | 0.238 | 0.250 | 0.239 |
| 17 | 0.161 | 0.170 | 0.170 | 0.158 | 0.150 | 0.160 |

As can be seen from Table 2, different weighting factors are assigned to different optical path lengths at different concentrations by using a weighting method, and both the problem of low OD reading at a high concentration and the problem of discontinuity between diluted and undiluted data are solved. Furthermore, the underestimation of the reading of a 1 cm optical path length for the yeast at a high concentration is more severe. Therefore, the measurement effect using the new method is more significant.

The foregoing description is only a preferred embodiment of the present disclosure and is not intended to limit the present disclosure. For those skilled in the art, various modifications and variations can be made to the present disclosure. Any modifications, equivalent substitutions, improvements and the like made within the spirit and principles of the present disclosure should be included within the scope of protection of the present disclosure.

1. A measurement cuvette for determining a concentration of a particulate suspension, wherein measurement cuvette has an L-shaped cross section defined by removal of a rectangular notch from a square body; and
the cuvette is formed of a fully transparent material.

2. The measurement cuvette for determining a concentration of a particulate suspension according to claim 1, wherein the cuvette is made of polystyrene.

3. The measurement cuvette for determining a concentration of a particulate suspension according to claim 1, wherein the cuvette has a height ranging from 4 cm to 5 cm.

4. The measurement cuvette for determining a concentration of a particulate suspension according to claim 1, wherein a square cross section of the cuvette has a side length ranging from 0.8 cm to 1.2 cm.

5. The measurement cuvette for determining a concentration of a particulate suspension according to claim 4, wherein the square cross section of the cuvette has a side length of 1 cm, and the rectangular notch has a length ranging from 7 mm to 9 mm and a width ranging from 5 mm to 6 mm.

6. A method for determining a concentration of a particulate suspension, comprising the following steps:
introducing a particulate suspension to be tested into a cuvette according to claim 5, and measuring absorbance of the cuvette at a plurality of optical path lengths, wherein a maximum optical path length of the cuvette is an optical path length 1, an intermediate optical path length is an optical path length 2, and minimum optical path length is an optical path length 3;
a weighting factor of an OD (Optical Density) value of the optical path length 1 is w1=X1/(X1+bX2E+CX3F);
a weighting factor of an OD value of the optical path length 2 is w2=bX2E/(X1+bX2E+CX3F);
a weighting factor of an OD value of the optical path length 3 is w3=cX3F/(X1+bX2E+CX3F);
a final OD value of the particulate suspension is X=w1X1+w2X2+w3X3, wherein
X1 is an OD value corresponding to the optical path length 1, X2 is an OD value corresponding to the optical path length 2, and X3 is an OD value corresponding to the optical path length 3;
b and c are real numbers and greater than or equal to 0; and E and F are real numbers and greater than or equal to 0.

7. The method for determining a concentration of a particulate suspension according to claim 6, wherein specific values of b and c are calibrated via a preliminary experiment using a substance to be tested, such that the maximum optical path length has a highest weighting factor at a low concentration, and the minimum optical path length has the highest weighting factor at a high concentration.

8. The method for determining a concentration of a particulate suspension according to claim 6, wherein specific values of E and F are calibrated via a preliminary experiment using a substance to be tested, such that the maximum optical path length has a highest weighting factor at a low concentration, and the minimum optical path length has the highest weighting factor at a high concentration.

9. The method for determining a concentration of a particulate suspension according to claim 6, wherein values of b, c, E, and F are obtained by data fitting.

10. The method for determining a concentration of a particulate suspension according to claim 6, wherein when detected by spectrophotometry, the particulate suspension to be tested has absorbance exceeding 1.0.
